(19) United States
(12) Patent Application Publication
(10) Pub. No.: US 2026/0223820 A1
(43) Pub. Date: Aug. 6, 2026

(54) ENHANCED SMART ANIMAL COLLAR SYSTEM

(71) Applicant: Pistoun and Garsha, LLC, The Woodlands, TX (US)

(72) Inventors: Alexei Pistoun, The Woodlands, TX (US); Adam Michael Garsha, Mequon, WI (US)

(73) Assignee: Pistoun and Garsha, LLC, The Woodlands, TX (US)

(21) Appl. No.: 19/307,440

(22) Filed: Aug. 22, 2025

Related U.S. Application Data
(60) Provisional application No. 63/686,165, filed on Aug. 23, 2024.

(51) Int. Cl. A01K 27/00; A01K 11/00; E05B 47/00

(52) U.S. Cl. CPC A01K 27/001; A01K 11/008; E05B 47/0001; E05B 2047/0058; E05B 2047/0064

(57) ABSTRACT

An enhanced smart animal collar system and a biometric lock system that includes a security platform having a biometrically actuated lock actuator that prevents unauthorized collar removal. The enhanced smart animal collar system also includes an animal tracking platform to follow, observe, watch, and track the movement of the animal over a plurality of tracking observations.

### CROSS REFERENCE TO RELATED APPLICATION

This application claims benefit to U.S. Provisional Application No. 63/686,165, filed Aug. 23, 2024, which is incorporated by reference herein in its complete entirety.

### TECHNICAL FIELD

One or more embodiments of the present disclosure relate generally to an enhanced smart animal collar system, and biometric lock system that includes a security platform having a biometrically actuated lock actuator that prevents unauthorized collar removal. The enhanced smart animal collar system also includes an animal tracking platform to follow, observe, watch, and track the movement of the animal over a plurality of tracking observations.

### BACKGROUND

Contemporary animal collars are increasingly equipped with a variety of electronic components to support tracking, health monitoring, and communication functions. These devices typically incorporate sensors for measuring biometric data, location determination systems such as GPS or cellular triangulation, and wireless (WL) communication modules for transmitting data to remote devices or servers. In many cases, collars are designed with modular or detachable components to facilitate maintenance, recharging, and firmware updates.

Additionally, some systems include haptic, audio, or visual feedback mechanisms to assist in training or alerting the animal. Others integrate with home automation systems or containment zones through geofencing and proximity detection technologies. Despite these advancements, the integration of multiple functionalities into a single wearable device presents challenges in terms of durability, signal integrity, and user accessibility. A common limitation in current animal collar systems is the vulnerability to unauthorized removal. Many devices rely on conventional fastening mechanisms or basic locking systems that can be manipulated or disengaged by the animal or third parties. This issue is particularly critical in scenarios where the collar serves as a primary means of identification or location tracking. In some cases, collars include key-based or code-activated locks to deter tampering; however, these mechanisms often lack the sophistication required to prevent determined removal.

The absence of a secure and tamper-resistant attachment method compromises the effectiveness of the collar in fulfilling its intended purpose. Furthermore, while many existing collars provide location tracking capabilities, the reliability and accuracy of these systems can be inconsistent, especially in environments with limited signal coverage. Some devices rely on satellite-based positioning, while others use cellular or Wi-Fi networks to determine location. However, these systems may not always provide real-time data or sufficient precision for effective monitoring. Additionally, power management remains a challenge, as continuous tracking and sensor operation can rapidly deplete battery resources. Although some collars include solar charging or low-power modes, these features are not universally implemented or optimized for all operational conditions.

The integration of biometric authentication into animal collars is also limited in current implementations. While some systems use microchip identification or RFID tags for verification, these methods do not provide dynamic biometric authentication. As a result, there is a gap in the ability to ensure that the collar remains securely attached to the correct animal at all times. This limitation reduces the overall security and reliability of the device, particularly in multi-pet households or public environments where misidentification could lead to serious consequences. In summary, while existing animal collar systems offer a range of features for monitoring and tracking, they often fall short in addressing the critical issues of secure attachment and reliable location determination. The need for a more robust solution that enhances both the physical security and functional performance of these devices remains unmet in the current landscape.

### SUMMARY

The present disclosure introduces an enhanced smart animal collar system and a biometric lock system having a biometrically actuated lock actuator integrated with a tracking platform, offering a technically distinct approach to securing and monitoring animal collars. Unlike conventional systems that rely on mechanical locks or basic fastening methods, the implementation of an electro-mechanical lock actuator controlled by biometric authentication provides a higher level of security by ensuring that only authorized individuals can unlock and remove the collar. This is achieved through an embedded biometric sensor and controller that captures and compares user-specific data, enabling automatic and secure unlocking without manual intervention. The integration of a WL tracking device, including GPS, RFID, Bluetooth, and UWB technologies, allows for continuous and accurate geo-positioning data transmission to the client device of one or more authorized, authenticated users, thereby enhancing real-time monitoring capabilities beyond what is typically available in existing devices. Additionally, the inclusion of a tamper-proof housing and a modular design that supports various power sources, such as solar or WL charging, ensures long-term operational reliability and adaptability in diverse environments. These technical features collectively address the limitations of prior systems by combining secure access control with advanced tracking functionality in a compact, durable, and energy-efficient form factor.

In one implementation, the enhanced smart animal collar system comprises one or more of the following: a housing having a tamper-resistant housing body operatively connected to a lock tab; a strap or collar member that is coupled to the lock tab; a biometrically-actuated lock actuator operatively connected to the housing and the strap; a tracking device; and a controller supported in the housing and operatively connected to the lock actuator and the tracking device.

The lock tab is coupled to one end of the collar member. The lock actuator is selectively moveable between a locked operating state to maintain the collar member on an animal and an unlocked operating state to facilitate removal of the collar by an authenticated user. The biometric locking system includes one or more biometric sensors operable to capture biometric data from an authenticated user and transmit the captured biometric data to the controller for comparison to stored biometric data of one or more authenticated users. Based on authentication of the biometric data, the controller automatically transmits one or more command output signals to a lock actuator to facilitate automatic movement of the locking mechanism from the locked operating state to the unlocked operating state, thereby preventing unauthorized collar removal. The animal tracking platform includes one or more sensors that are configured to capture geo-positioning data of the movement of the animal over a plurality of sensor observations, and transmit the geo-positioning data to a user device (e.g., mobile device) indicating the current location of the animal to the authenticated user.

In another implementation, the enhanced smart animal collar system comprises one or more of the following: a housing body having a strap receiver coupled to a first strap region of an elongated strap for releasable attachment on an animal, and a lock tab releasably coupled at a first region thereof to the housing and at a second region thereof to the second strap region of the elongated strap; a (e.g., electro-mechanical) a lock actuator movable between a locked operating state that maintains the coupling of the lock tab to the housing, and an unlocked operating state that facilitates release of the coupling between the lock tab and the housing; a controller to control the lock actuator, the controller including a processor operable to perform operations including: storing biometric data of an authorized, authenticated user as stored biometric data, acquiring an input signal that corresponds to captured biometric sensor data, performing biometric authentication for identity verification of any authorized, authenticated user (among the one or more authorized, authenticated users) by comparing captured biometric sensor data with stored biometric data associated with any authorized, authenticated user, and automatically transmitting, in response to successful biometric authentication of the captured biometric sensor data, one or more command output signals to the lock actuator to move the lock tab from the locked operating state to the unlocked operating state and thereby prevent unauthorized removal of the strap from the animal.

In a further implementation, an enhanced smart animal collar system comprises one or more of the following: a housing body having a strap receiver coupled to a first strap region of an elongated strap for releasable attachment on an animal, and a lock tab releasably coupled at a first region thereof to the housing and at a second region thereof to the second strap region of the elongated strap; a lock actuator movable between a locked operating state that maintains the coupling of the lock tab to the housing, and an unlocked operating state that facilitates release of the coupling between the lock tab and the housing; and a controller to control the lock actuator, the controller including a processor operable to perform operations including: performing biometric authentication for identity verification by comparing captured biometric sensor data with stored biometric data associated with any authorized, authenticated user, and automatically transmitting, in response to successful biometric authentication of the captured biometric sensor data, one or more command output signals to the lock actuator to move the lock tab from the locked operating state to the unlocked operating state.

In an additional implementation, an enhanced smart animal collar system comprises one or more of the following: a housing body having a strap receiver coupled to a first strap region of an elongated strap for releasable attachment on an animal, and a lock tab releasably coupled at a first region thereof to the housing and at a second region thereof to the second strap region of the elongated strap; a lock actuator movable between a locked operating state that maintains the coupling of the lock tab to the housing, and an unlocked operating state that facilitates release of the coupling between the lock tab and the housing; and a controller to control the lock actuator, the controller including a processor operable to perform operations including: acquiring an input signal that corresponds to captured tracking data, automatically transmitting one or more tracking signals (corresponding to the captured tracking data) to an authenticated client device of any authorized, authenticated user indicating a current geographic location of the enhanced smart animal collar system, performing biometric authentication for identity verification by comparing captured biometric sensor data with stored biometric data associated with any authorized, authenticated user, and automatically transmitting, in response to successful biometric authentication of the captured biometric sensor data, one or more command output signals to the lock actuator to move the lock tab from the locked operating state to the unlocked operating state.

In accordance with the present disclosure, the enhanced smart animal collar system further comprises a sensor module comprising one or more biometric sensors operable to capture biometric attribute information as the biometric sensor data.

In accordance with the present disclosure, the one or more biometric sensors are embedded in an outer surface of the housing body.

In accordance with the present disclosure, further comprising a WL tracking device operable to facilitate WL monitoring of the enhanced smart animal collar system by any authorized, authenticated user.

In accordance with the present disclosure, the WL tracking device is operable to transmit one or more signals as geo-positioning data that enables the capture of geo-positioning data of the enhanced smart animal collar system.

In accordance with the present disclosure, the WL tracking device is operable to transmit one or more signals as geo-positioning data to an authenticated client device (e.g., a mobile device) of any authorized, authenticated user to indicate a current geographic location of the enhanced smart animal collar system. In that way, any authorized, authenticated user may advantageously access the captured geo-positioning data by registering with an enterprise mobile application and monitoring the location of the enhanced smart animal collar system.

In accordance with the present disclosure, the WL tracking device comprises one or more of an RFID tag, a GPS tag, a Bluetooth® tag, and an ultra-wideband (UWB) tag.

In accordance with the present disclosure, the WL tracking device may be supported by a WL tracking device housing. Alternatively, the WL tracking device may be embedded in a surface of the housing. Alternatively, the WL tracking device is supported in the cavity of the housing body.

In accordance with the present disclosure, in the locked operating state, the lock tab maintains a coupling of the housing to the elongated strap member to maintain the enhanced smart animal collar system on the animal.

In accordance with the present disclosure, in the unlocked operating state, the lock tab permits removal of the enhanced smart animal collar system from the animal by any authorized, authenticated user.

In accordance with the present disclosure, the controller is supported in a cavity of the housing body. The controller may include a power source. The power source may comprise WL charging hardware to facilitate charging via proximity to a charging field. Alternatively or additionally, the power source may comprise solar charging hardware to facilitate charging via solar power.

In accordance with the present disclosure, the lock actuator is supported in a cavity of the housing body.

In accordance with the present disclosure, the set of instructions are executable by the processor to cause the processor to perform operations further including automatically maintaining, in response to unsuccessful biometric authentication, the lock tab in the locked operating state.

In another implementation, a biometric lock system for an animal collar comprises one or more of the following: a lock tab releasably coupled to a collar housing and an elongated strap; an electro-mechanical lock actuator a lock actuator movable between a locked operating state that maintains the coupling of the lock tab to the housing, and an unlocked operating state that facilitates release of the coupling between the lock tab and the housing; a controller to control the lock actuator, the controller including a processor operable to perform operations including: storing biometric data of an authorized, authenticated user as stored biometric data, acquiring an input signal that corresponds to captured biometric sensor data, performing biometric authentication for identity verification of any authorized, authenticated user by comparing captured biometric sensor data with stored biometric data associated with any authorized, authenticated user, and automatically transmitting, in response to successful biometric authentication of the captured biometric sensor data, one or more command output signals to the lock actuator to move the lock tab from the locked operating state to the unlocked operating state and thereby prevent unauthorized removal of the strap from the animal.

In a further implementation, a biometric lock system for an animal collar comprises one or more of the following: a lock tab releasably coupled at a first region thereof to a collar housing and at a second region thereof to an elongated strap; a lock actuator movable between a locked operating state that maintains the coupling of the lock tab to the housing, and an unlocked operating state that facilitates release of the coupling between the lock tab and the housing; and a controller to control the lock actuator, the controller including a processor operable to perform operations including: performing biometric authentication for identity verification by comparing captured biometric sensor data with stored biometric data associated with any authorized, authenticated user, and automatically transmitting, in response to successful biometric authentication of the captured biometric sensor data, one or more command output signals to the lock actuator to move the lock tab from the locked operating state to the unlocked operating state.

### DRAWINGS

FIG. 1 illustrates a front perspective view of an enhanced smart animal collar system having a lock tab in a locked operating state which maintains a coupling of the housing to an elongated strap member that is worn by the animal, in accordance with one or more embodiments set forth and described herein.

FIG. 2 illustrates a front view of the enhanced smart animal collar system of FIG. 1.

FIG. 3 illustrates a top view of the enhanced smart animal collar system of FIG. 1.

FIGS. 4 through 6 respectively illustrate a perspective view of the enhanced smart animal collar system of FIG. 1, in an unlocked operating state.

FIG. 7 illustrates a communication environment for the enhanced smart animal collar system, in accordance with one or more embodiments set forth and described herein.

FIG. 8 illustrates a block diagram of the enhanced smart animal collar system of FIG. 1.

FIG. 9 illustrates a block diagram of a controller for the enhanced smart animal collar system of FIG. 8.

FIG. 10 illustrates a diagram of one or more control blocks for the controller of FIG. 9.

FIG. 11 illustrates a computer-implemented method for operating an enhanced smart animal collar system, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (Al)” relates to one or more computer system operable to perform one or more tasks that normally require human intelligence, such as visual perception, speech recognition, decision-making, and translation between languages.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a WL tablet.

As used herein, “client device” relates to any device associated with a user, including personal computers, laptops, tablets, and/or mobile smartphones.

As used herein, “modules” or “engines” relates to either software modules/engines (e.g., code embodied on a machine-readable medium or in a transmission signal) or hardware modules/engines. Certain embodiments are described herein as including logic or a number of components, modules/engines, or mechanisms. A hardware module/engine (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware module/engine of a computer system (e.g., a processor or a group of processors) may be configured by software (e.g., an application or application portion) as a hardware module/engine that operates to perform certain operations as described herein. In some embodiments, a hardware module/engine may be implemented mechanically, electronically, or any suitable combination thereof. For example, a hardware engine may include dedicated circuitry or logic that is permanently configured to perform certain operations. For example, a hardware module/engine may be a special-purpose processor, such as an FPGA or an ASIC. A hardware module/engine may also include programmable logic or circuitry that is temporarily configured by software to perform certain operations. A hardware module/engine may include software encompassed within a general-purpose processor or other programmable processor. It will be appreciated that the decision to implement a hardware module/engine mechanically, in dedicated and permanently configured circuitry, or in temporarily configured circuitry (e.g., configured by software) may be driven by cost and time considerations.

Accordingly, the phrase “hardware module/engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module/engine” refers to a hardware module/engine. Considering embodiments in which hardware engines are temporarily configured (e.g., programmed), each of the hardware engines need not be configured or instantiated at any one instance in time. For example, where a hardware module/engine comprises a general-purpose processor configured by software to become a special-purpose processor, the general-purpose processor may be configured as respectively different special-purpose processors (e.g., comprising different hardware engines) at different times. Software may accordingly configure a processor, for example, to constitute a particular hardware module/engine at one instance of time and to constitute a different hardware module/engine at a different instance of time. Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access.

As used herein, “network” or “networks” relates to any combination of electronic communication networks, including without limitation the Internet, a local area network (LAN), a wide area network, a WL network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module/engine” relates to a hardware module/engine implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

As used herein, “server” relates to a server computer or group of computers that acts to provide a service for a certain function or access to a network resource. A server may be a physical server, a hosted server in a virtual environment, or software code executing on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module/engine, or system senses as sufficiently immediate for a particular process or determination to be made, or that enables the processor to keep up with some external process.

As used herein, “user” relates to a consumer, machine entity, and/or requesting party, and may be human or machine.

The present disclosure introduces an enhanced smart animal collar system having a biometrically actuated lock actuator integrated with a tracking platform, offering a technically distinct approach to securing and monitoring animal collars. Unlike conventional systems that rely on mechanical locks or basic fastening methods, the implementation of an electro-mechanical lock actuator controlled by biometric authentication provides a higher level of security by ensuring that only authorized individuals can unlock and remove the collar. This is achieved through an embedded biometric sensor and controller that captures and compares user-specific data, enabling automatic and secure unlocking without manual intervention. The integration of a WL tracking device, including GPS, RFID, Bluetooth, and UWB technologies, allows for continuous and accurate geo-positioning data transmission to the client device of any authorized, authenticated user, thereby enhancing real-time monitoring capabilities beyond what is typically available in existing devices. Additionally, the inclusion of a tamper-proof housing and a modular design that supports various power sources, such as solar or WL charging, ensures long-term operational reliability and adaptability in diverse environments. These technical features collectively address the limitations of prior systems by combining secure access control with advanced tracking functionality in a compact, durable, and energy-efficient form factor.

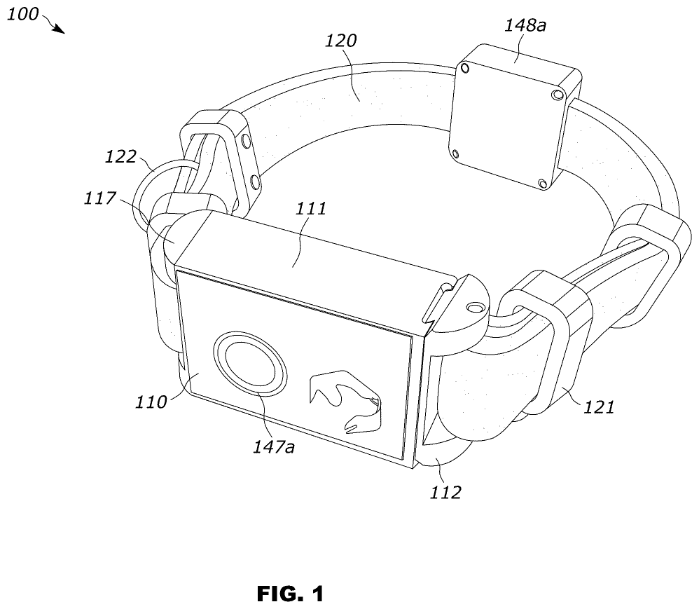

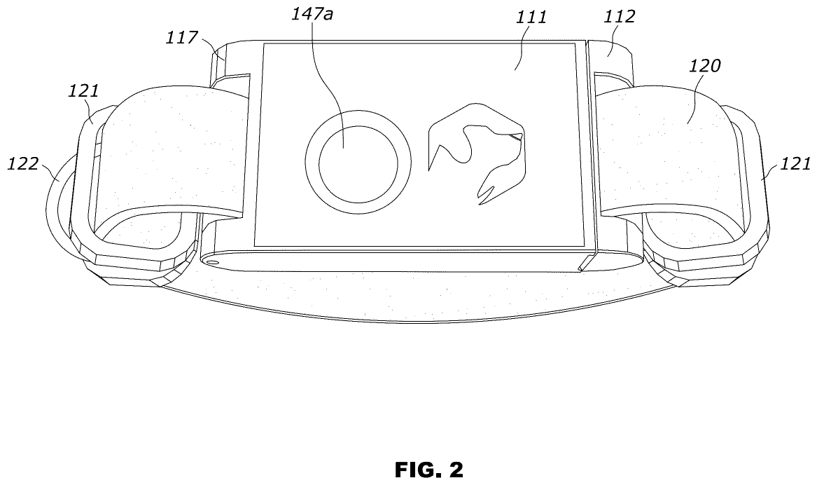

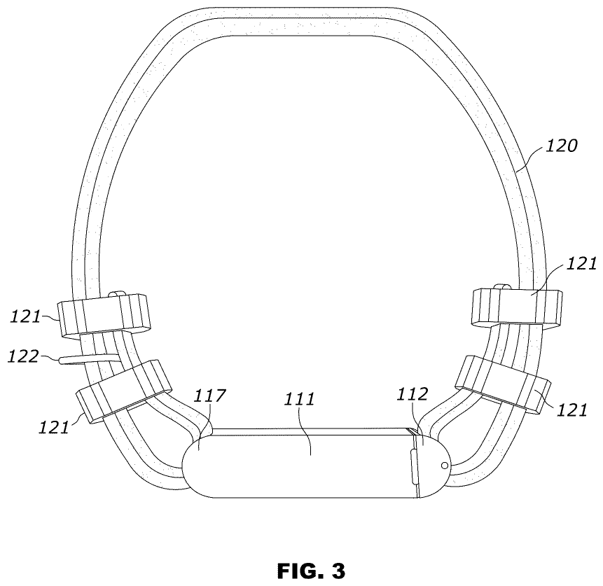

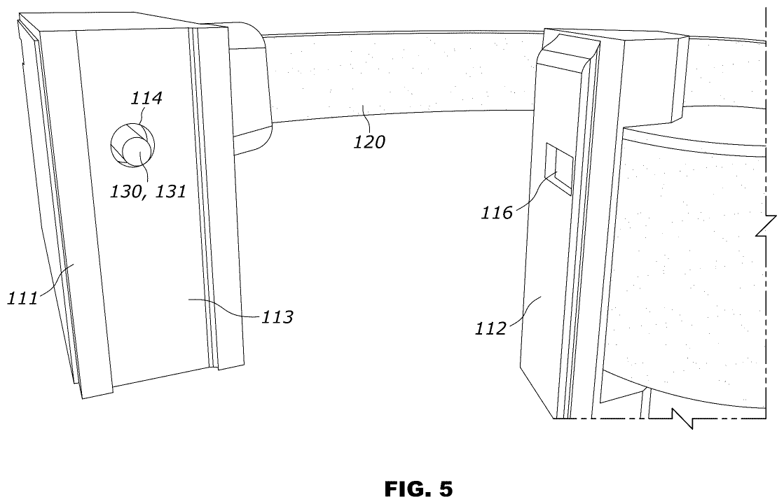

Turning to the figures, in which FIGS. 1 through 6 respectively illustrate an enhanced smart animal collar system 100 which includes a tamper-resistant housing 110 for an elongated strap 120 operable for receipt around the body (e.g., neck, limb, torso, etc.) of an animal such as, for example, a domesticated animal.

The elongated strap 120 may be formed of braided aluminum wire enclosed by a stitched nylon cover to create a composite cable that does not create discomfort when worn by the animal while also making it challenging to be tampered. This disclosure contemplates forming the elongated strap 120 using a curved metal beam, a metal chain enclosed by leather, or any type of mechanically cord formed of a robust material.

The tamper-resistant housing 110 has a bifurcated structural configuration comprising a housing body 111 and a lock tab 112. The housing body 111 is operable for coupling to an end region of the elongated strap 120, while the lock tab 112 is operable for coupling at a first region thereof to the housing body 111 and at second region thereof to an opposite end region of the elongated strap 120. One or more strap adjusters 121 may be arranged on the strap 120 to facilitate manual selective adjustment of the strap 120 to accommodate animals of various size. A leash/ID tag ring 122 may also be arranged on the strap 120 to facilitate coupling to a leash and/or receive an animal ID tag.

The housing body 111 defines an interior space to receive the electro-mechanical lock actuator 130, the controller 140, and a power source 150. The housing body 111 and the lock tab 112 may be fabricated via additive manufacturing (3D printing) using a durable material that is resistant to tampering (e.g., polymer resin). Alternatively, the housing body 111 and the lock tab 112 may be fabricated via subtractive manufacturing using polymers, a metals, etc. Embodiments, however, are not limited thereto. This disclosure contemplates fabricated the housing body 111 and the lock tab 112 of any suitable material that falls within the spirit and scope of the principles of this disclosure. For example, the housing body 111 and the lock tab 112 may be fabricated using composite materials to form a composite structure.

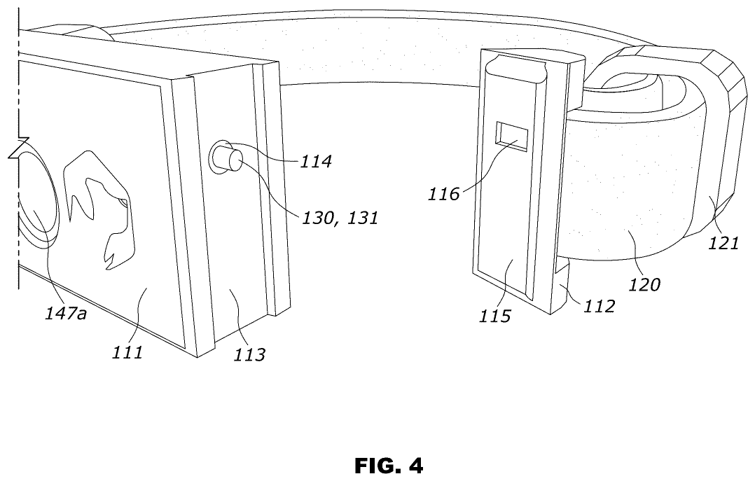

As illustrated in FIGS. 4 through 6, the housing body 111 and the lock tab 112 are releasably coupled at an interface via a mechanical joint to maintain the enhanced smart animal collar system 100 on the animal. In the illustrated embodiment, the mechanical joint comprises a dovetail joint that forms a tamper resistant coupling when the lock actuator 130 is in a locked operating state. A sidewall of the housing body 111 includes a strap receiver 117 operable for coupling to a first strap region of the elongated strap 120. An opposite sidewall of the housing body 111 is formed as a dovetail slot 113 operable to receive a dovetail protrusion 115 arranged on an opposing sidewall of the lock tab 112. This disclosure contemplates forming the outer surface of the housing body 111 as a dovetail protrusion and forming the lock tab 112 as a dovetail slot operable to receive a corresponding dovetail protrusion. This disclosure contemplates coupling the housing body 111 and the lock tab 112 using any suitable technique that falls within the spirit and scope of the principles of this disclosure. The same outer surface of the housing body 111 includes a hole 114 through which a plunger 131 of the lock actuator 130 protrudes when advances forward for receipt into a recess 116 of a dovetail protrusion 115 when the lock actuator 130 is in a locked operating state. The lock actuator 130 is moved to the unlocked operating state in response receipt of one or more command output signals S from the one or more processors 141 (in response to successful biometric authentication of an authorized authenticated user) of the controller 140 that causes actuation of the solenoid. Such actuation thereby causes the plunger 131 to retract in a rearward direction away from and out of the recess 116, when then allows any authorized, authenticated user to manually disengage the dovetail protrusion 115 from the dovetail slot 113

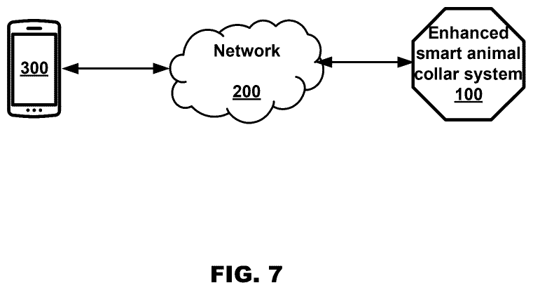

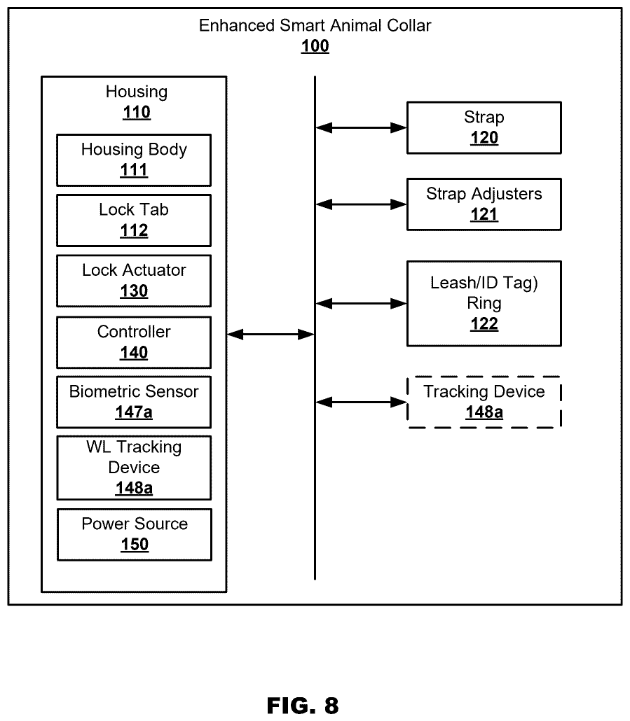

As illustrated in FIG. 7, a network communication environment that facilitates communications between the enhanced smart animal collar system 100 (via controller 140) and a client device 300 of an authorized authenticated user. The client device 300 operating in the network communication environment facilitates access by any authorized, authenticated user to tracking data associated with the enhanced smart animal collar system 100. The communication environment includes the enhanced smart animal collar system 100, the client device 300, and a communication network 200 through which communication is facilitated between the enhanced smart animal collar system 100 and the client device 300.

In accordance with one or more embodiments set forth, described, and/or illustrated herein, the client device 300 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 300 comprising any form of electronic device that optimizes or otherwise transforms the performance and functionality of the one or more embodiments in a manner that falls within the spirit and scope of the principles of this disclosure.

In the illustrated example embodiment of FIG. 7, the client device 300 comprises a mobile device. In accordance with one or more embodiments set forth, described, and/or illustrated herein, the client device 300 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 300 comprising any form of electronic device that optimizes or otherwise transforms the performance and functionality of the one or more embodiments in a manner that falls within the spirit and scope of the principles of this disclosure.

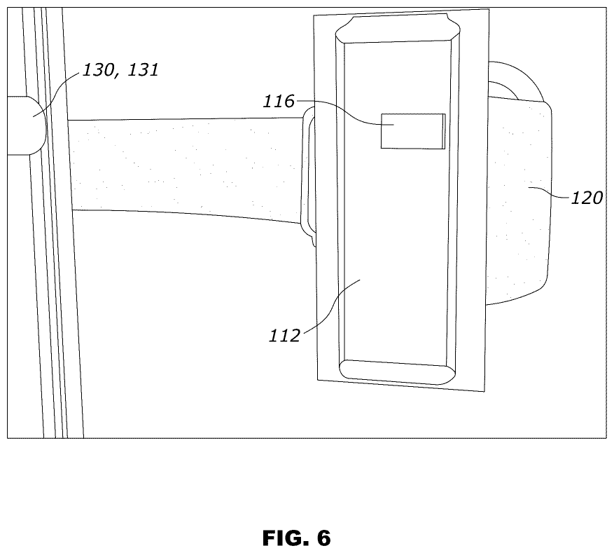

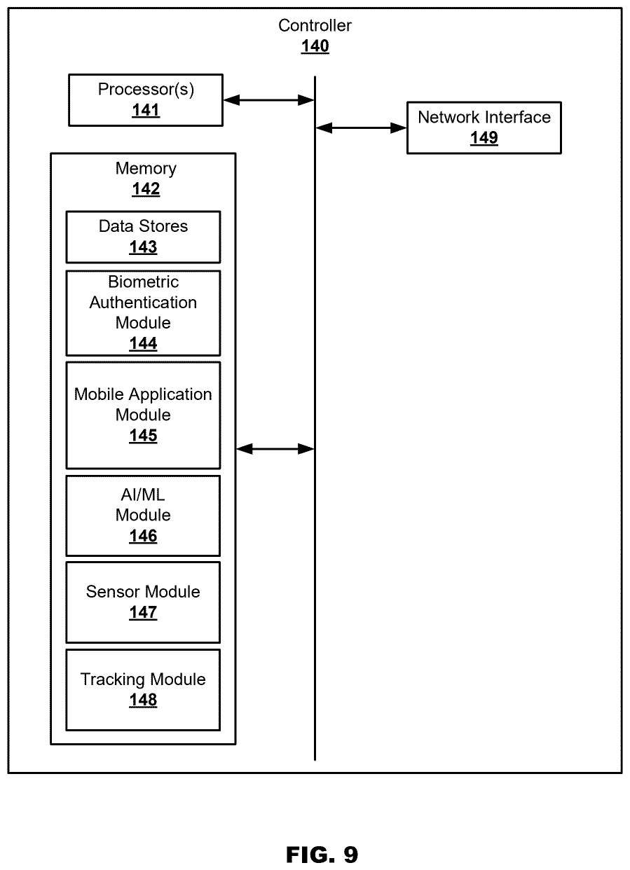

As illustrated in FIG. 9, the controller 140 includes one or more processors 141, a non-transitory memory 142 operatively coupled to the one or more processors 141, a network interface 80, and a sensor module 147. Some of the possible operational elements of the controller 140 are illustrated in FIG. 6 and will now be described herein. It will be understood that it is not necessary for the controller 140 to have all the elements illustrated in FIG. 6. For example, each server in the controller 140 may have any combination of the various elements illustrated in FIG. 6. Moreover, the controller 140 may have additional elements to those illustrated in FIG. 6.

The memory 142 comprises a set of executable instructions of computer-executable program code. The set of executable instructions are executable by the one or more processors 141 in manner that facilitates control of the lock actuator 130. The memory 142 also includes one or more data stores 143, a biometric authentication module 144, a mobile application module 145 for the mobile application, an artificial intelligence (Al)/machine learning (ML) module 146, a sensor module 147, and a tracking module 147. In accordance with one or more embodiments set forth, described, and/or illustrated herein, the controller 140 may individually or collectively execute the instructions (which are stored) to perform (or cause to be performed) any one or more of the methodologies set forth, described, and illustrated herein.

The one or more data stores 143 are operable to store one or more types of data, including but not limited to, biometric authentication data, sensor data, etc. The one or more data stores 143 may comprise volatile and/or non-volatile memory. Examples of suitable data stores 143 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 143 may be a component of the one or more processors 141, or alternatively, may be operatively connected to the one or more processors 141 for use thereby. As set forth, described, and/or illustrated herein, “operatively connected” may include direct or indirect connections, including connections without direct physical contact.

The memory 142 may comprise a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 141 cause the controller 140 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The memory 142 can store computer readable program code and data which, when executed by the one or more processors 141 (or other processor(s)) can implement (or cause to be implemented) any of the features and methodologies described herein.

The biometric authentication module 144 is operable to verify the identity of any authorized, authenticated user by implementing one or more authentication protocols that map the biometric authentication credentials of any authorized, authenticated user to stored biometric authentication credentials of any authorized, authenticated user. The biometric authentication module 144 may include redundant authentication protocols, including, but not limited to, multi-factor authentication, a user passcode-based authentication, a cookie, a private key, token-based authentication, and/or another suitable authentication protocol.

The mobile application module 145 is operable to communicate with the client device 300 that has launched an enterprise mobile application associated with the enhanced smart animal collar system 100 to facilitate access to an account by an authorized, authenticated user.

The AI/ML module 146 may comprise one or more Al/ML processors operable to perform or otherwise implement accelerated processing of the one or more methods set forth and described herein. The one or more Al/ML processors are operable to perform operations involving machine learning (ML) by generating a trained ML model. The AI/ML module 146 includes one or more ML algorithms to train one or more machine learning models as a trained ML model based on data and/or information residing in the memory 142 and/or one or more storage locations (e.g., one or more databases). The ML algorithms may include one or more of a linear regression algorithm, a logical regression algorithm, or a combination of different algorithms. A neural network may also be used to train the system based on the received data. The AI/ML module 146 may analyze the received data and/or information, and transform the data and/or information in a manner which provides enhanced communication between the controller 140 and the client device 300, while also enhancing user access and user management of the user account. The data and/or information may also be up-linked to other systems, subsystems, components, and modules of the enhanced smart animal collar system 100 for further processing to discover additional information that may be used to enhance the understanding of the information.

The sensor module 147 is operable to dynamically detect, determine, assess, monitor, measure, quantify, and/or sense information about the enhanced smart animal collar system 100 and any authorized, authenticated user. The sensor module 147 is operable to detect, determine, assess, monitor, measure, quantify and/or sense in real-time. The sensor module 147 is further operable to detect, determine, assess, monitor, measure, quantify, and/or sense geographic location information about the geographic location of the enhanced smart animal collar system 100, and dynamically transmit a signal to the client device 300 (via the mobile application module 145) that has successfully gained authenticated access into the enterprise mobile application.

The sensor module 147 comprises one or more sensors, including, but not limited to, a biometric sensor 147a comprising a reader operable to capture biometric attribute information (e.g., facial, fingerprint, voice, ocular, etc.) as biometric data. In the illustrated embodiment, the biometric sensor 147a is embedded in an outer surface of the housing body 111. This disclosure contemplates arranging the biometric sensor 147a in any suitable location with respect to the housing body 111. The biometric sensor 147a may work in combination with other components, subsystems of the enhanced smart animal collar system 100, and may be used in any combination with other biometric sensors for purposes of redundancy to validate and enhance the accuracy of the biometric detection of the biometric attributes. The computer-executable program code may instruct the one or more processors 141 to cause the biometric authentication module 144 to biometrically authenticate any authorized, authenticated user in order to control the lock actuator 130, namely by causing the one or more processors 141 to automatically transmit, in response to successful biometric authentication of captured biometric sensor data, one or more command output signals S₄ to cause actuation of the lock actuator 130.

The tracking module 148 is operatively connected to a WL tracking device 148a that is operable to facilitate WL short-and long-range tracking or monitoring of the enhanced smart animal collar system 100 by any authorized, authenticated user. In operation, the WL tracking device 148a is operable to transmit one or more signals as geo-positioning data to an authenticated client device 300 indicating a current geographic location of the enhanced smart animal collar system 100. The WL tracking device may comprise one or more of an RFID tag, a GPS tag, a Bluetooth tag, and an ultra-wideband (UWB) tag. In the illustrated embodiment of FIG. 1, the WL tracking device 148a is supported by a wearable housing having a structure that enables coupling to the strap 120. This disclosure contemplates, however, an arrangement in which the WL tracking device 148a is embedded in a surface of the housing body 111 or supported in a cavity of the housing body 111.

The enhanced smart animal collar system 100 may utilize the capabilities of a monitoring as a service (MaaS) interface (not illustrated) to facilitate the deployment of monitoring functionalities in a cloud environment. The MaaS interface would thereby facilitate tracking by the tracking module 148 within a cloud-based communication environment.

in accordance with an example embodiment, the controller 140 is operable to control the lock actuator 130. The non-transitory memory 142 including a plurality of executable program instructions, which when executed by the one or more processors 141, cause the one or more processors 141 to perform one or more operations including: acquiring an input signal St that corresponds to captured biometric sensor data, performing biometric authentication for identity verification by comparing the captured biometric sensor data with stored biometric data associated with an authorized, authenticated user, and automatically transmitting, in response to successful biometric authentication of the captured biometric sensor data, one or more command output signals S₄ to move the lock actuator 130 from the locked operating state to the unlocked operating state.

The power source 150 may be operatively connected to one or more components, systems and subsystems, such as, for example, the lock actuator 130, the controller 140, the biometric sensor 147a, and the WL tracking device 148a. The power source 150 may be operable to activate and/or reset the lock actuator 130, the biometric sensor 147a and the WL tracking device 148a.

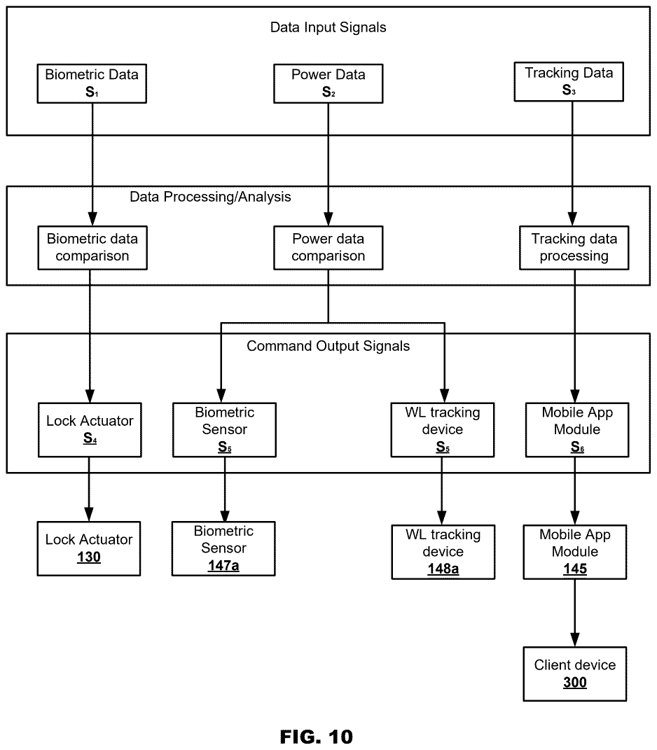

In one or more example embodiments, for purposes of power management, the power source 150 is controlled by the controller 140. As illustrated in FIG. 10, during operation, the controller 140 can dynamically monitor power usage by the enhanced smart animal collar system 100 by acquiring or receiving one or more input signals S₂ from the power source 150 as power data that corresponds to a level or magnitude of power remaining in the power source 150. The level or magnitude of power may then be compared to a predefined threshold value to determine whether the current power level is too low. In instances where the current power level is too low and thus, power should be decreased, the controller 140 can transmit one or more control signals S₅ (e.g., one or more interrupt signals) to temporarily deactivate one or more of the largest consumer(s) of power (e.g., the biometric sensor 147a and/or the tracking device 148a). The disclosure contemplates implementing alternative protocols to manage power within the enhanced smart animal collar system 100.

In accordance with the present disclosure, the power source 150 is supported in the cavity of the housing body 111. The power source 150 may comprise WL charging hardware to facilitate charging via proximity to a charging field. Alternatively or additionally, the power source 150 may comprise solar charging hardware to facilitate charging via solar power. Alternatively or additionally, the power source 150 may comprise a wired power source that may be charged via a wired charging port. Alternatively or additionally, the power source 150 may comprise one or more rechargeable batteries having a plurality of rechargeable cells. For purposes of recharging the power source 150, an energy harvesting module may be provided, the energy harvesting module comprising one or more energy harvesting arrays operable to deliver harvested energy to the one or more rechargeable batteries. This disclosure contemplates use of any suitable configuration that falls within the spirit and scope of the principles of this disclosure set forth herein.

The lock actuator 130 may comprise a mechanical actuator, an electrical actuator, or an electro-mechanical actuator that is at least partially contained in the housing body 111 for operative connection (e.g., via a wired and/or WL coupling) to the controller 140. This disclosure contemplates the lock actuator 130 comprising any suitable configuration that falls within the spirit and scope of the principles of this disclosure. For example, such suitable actuator configuration may comprise motors, pneumatic actuators, hydraulic actuators, thermal actuators, magnetic actuators, mechanical actuators, relays, and/or piezoelectric actuators, etc.

In the illustrated exemplary embodiment, the lock actuator 130 comprises an electro-mechanical actuator such as, for example, a solenoid comprising a solenoid housing having a plunger 131. When the dovetail joint is formed by coupling of the dovetail slot 113 with the dovetail protrusion 115, the lock actuator 130 may be placed in the locked operating state in response to receipt of one or more command output signals S₁ from the one or more processors 141 of the controller 140. Such action causes the plunger 131 to advance forward for receipt into a recess 116 of the dovetail protrusion 115, thereby creating a tamper-resistant lock. The lock actuator 130 is moved to the unlocked operating state in response receipt of one or more command output signals S₁ from the one or more processors 141 (in response to successful biometric authentication of an authorized authenticated user) of the controller 140 that causes actuation of the solenoid. Such actuation thereby causes the plunger 131 to retract in a rearward direction away from and out of the recess 116, when then allows any authorized, authenticated user to manually disengage the dovetail protrusion 115 from the dovetail slot 113.

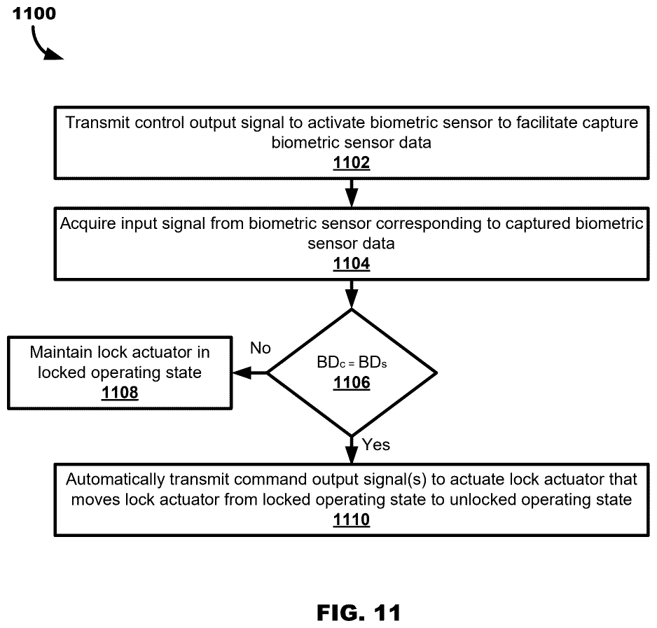

The illustrated example of FIG. 11 sets forth a computer-implemented method 1100. The flowchart of the computer-implemented method 1100 may be implemented by the one or more processors 141. In particular, the computer-implemented method 1100 may be implemented as one or more modules in a set of executable logic instructions stored in the non-transitory memory 142.

The accordance with the computer-implemented method 1100, illustrated process block 1102 includes transmitting a control signal (e.g., control signal S₅) to a biometric sensor (e.g., biometric sensor 147a) to activate the biometric sensor for purposes of capturing biometric attribute information as captured biometric sensor data.

The computer-implemented method 1100 may then proceed to illustrated process block 1104, which includes acquiring an input signal (e.g., St) from the biometric sensor that corresponds to the captured biometric sensor data.

The computer-implemented method 1100 may then proceed to illustrated decision block 1106, which includes performing biometric authentication for identity verification by comparing the captured biometric sensor data with stored biometric data associated with an authorized, authenticated user.

Should the captured biometric sensor data not match (i.e., below a predefined threshold percentage) the stored biometric data (i.e., decision block 1106 is answered in the negative or “No”), the computer-implemented method 1100 may then proceed to illustrated decision block 1108, which includes maintaining the lock actuator (e.g., lock actuator 130) in the locked operating state.

Should, on the other hand, the captured biometric sensor data match (i.e., at/above the predefined threshold percentage) the stored biometric data (i.e., decision block 1106 is answered in the affirmative or “Yes”), the computer-implemented method 1100 may then proceed to illustrated decision block 1110, which includes automatically transmitting, in response to successful biometric authentication of the captured biometric sensor data, one or more command output signals (e.g., command output signal S₄) to move the lock actuator from the locked operating state to the unlocked operating state.

The terms “coupled,” “attached,” or “connected” may be used herein to refer to any type of relationship, direct or indirect, between the components in question, and may apply to electrical, mechanical, fluid, optical, electromagnetic, electromechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An enhanced smart animal collar system, comprising:
a housing body having a strap receiver coupled to a first strap region of an elongated strap for releasable attachment on an animal, and a lock tab operable for coupling at a first region thereof to the housing and at a second region thereof to the second strap region of the elongated strap;
a lock actuator movable between a locked operating state that maintains the coupling of the lock tab to the housing, and an unlocked operating state that facilitates release of the coupling between the lock tab and the housing; and
a controller to control the lock actuator, the controller including a processor operable to perform operations including:
acquiring an input signal that corresponds to captured biometric sensor data,
performing biometric authentication for identity verification by comparing the captured biometric sensor data with stored biometric data associated with one or more authorized, authenticated users, and
automatically transmitting, in response to successful biometric authentication of the captured biometric sensor data, one or more command output signals to move the lock actuator from the locked operating state to the unlocked operating state.

2. The enhanced smart animal collar system of claim 1, further comprising a sensor module comprising one or more biometric sensors operable to capture biometric attribute information as the biometric sensor data.

3. The enhanced smart animal collar system of claim 2, wherein the one or more biometric sensors are embedded in an outer surface of the housing body.

4. The enhanced smart animal collar system of claim 2, further comprising a wireless (WL) tracking device operable to facilitate WL monitoring of the animal collar by any authorized, authenticated user among the one or more authorized, authenticated users.

5. The enhanced smart animal collar system of claim 4, wherein the WL tracking device is operable to transmit a signal that enables the capture of geo-positioning data of the enhanced smart animal collar system.

6. The enhanced smart animal collar system of claim 4, wherein the WL tracking device is operable to transmit geo-positioning data to an authenticated client device indicating a current geographic location of the enhanced smart animal collar system.

7. The enhanced smart animal collar system of claim 4, wherein the WL tracking device comprises one or more of an RFID tag, a GPS tag, a Bluetooth tag, and an ultra-wideband (UWB) tag.

8. The enhanced smart animal collar system of claim 4, wherein the WL tracking device is supported by a WL tracking device housing.

9. The enhanced smart animal collar system of claim 4, wherein the WL tracking device is embedded in a surface of the housing.

10. The enhanced smart animal collar system of claim 4, wherein the WL tracking device is supported in the cavity of the housing body.

11. The enhanced smart animal collar system of claim 1, wherein in the locked operating state, the lock tab maintains a coupling of the housing to the elongated strap member to maintain the enhanced smart animal collar system on the animal.

12. The enhanced smart animal collar system of claim 1, wherein in the unlocked operating state, the lock tab permits removal of the enhanced smart animal collar system from the animal by any authorized, authenticated user among the one or more authorized, authenticated users.

13. The enhanced smart animal collar system of claim 1, wherein the controller is supported in a cavity of the housing body.

14. The enhanced smart animal collar system of claim 1, further comprising a power source for the controller.

15. The enhanced smart animal collar system of claim 14, wherein the power source comprises WL charging hardware to facilitate charging via proximity to a charging field.

16. The enhanced smart animal collar system of claim 14, wherein the power source comprises solar charging hardware to facilitate charging via solar power.

17. The enhanced smart animal collar system of claim 1, wherein the lock actuator is supported in a cavity of the housing body.

18. The enhanced smart animal collar system of claim 1, wherein the set of instructions are executable by the one or more processors to cause the one or more processors to perform operations further including automatically maintaining, in response to unsuccessful biometric authentication, the lock tab in the locked operating state.

19. An enhanced smart animal collar system, comprising:
a housing body having a strap receiver coupled to a first strap region of an elongated strap for releasable attachment on an animal, and a lock tab releasably coupled at a first region thereof to the housing and at a second region thereof to the second strap region of the elongated strap;
a lock actuator movable between a locked operating state that maintains the coupling of the lock tab to the housing, and an unlocked operating state that facilitates release of the coupling between the lock tab and the housing; and
a controller to control the lock actuator, the controller including a processor operable to perform operations including:
performing biometric authentication for identity verification by comparing captured biometric sensor data with stored biometric data associated with one or more authorized, authenticated users, and
automatically transmitting, in response to successful biometric authentication of the captured biometric sensor data, one or more command output signals to the lock actuator to move the lock tab from a locked operating state to an unlocked operating state.

20. An enhanced smart animal collar system, comprising:
a housing body having a strap receiver coupled to a first strap region of an elongated strap for releasable attachment on an animal, and a lock tab releasably coupled at a first region thereof to the housing and at a second region thereof to the second strap region of the elongated strap;
a lock actuator movable between a locked operating state that maintains the coupling of the lock tab to the housing, and an unlocked operating state that facilitates release of the coupling between the lock tab and the housing; and
a controller to control the lock actuator, the controller including a processor operable to perform operations including:
acquiring an input signal that corresponds to captured tracking data,
automatically transmitting one or more tracking signals to an authenticated client device of one or more authorized, authenticated users indicating a current geographic location of the animal collar,
performing biometric authentication for identity verification by comparing captured biometric sensor data with stored biometric data associated with the one or more authorized, authenticated users, and
automatically transmitting, in response to successful biometric authentication of the captured biometric sensor data, one or more command output signals to the lock actuator to move the lock tab from a locked operating state to an unlocked operating state.
